(19) United States
(12) Patent Application Publication
(10) Pub. No.: US 2002/0053985 A1
(43) Pub. Date: May 9, 2002

(54) Method and system for providing corrected time dependent data across a wireless network

(76) Inventor: Bryce C. Nesbitt, Cambridge, MA (US)

Correspondence Address: Gibson, Dunn & Crutcher LLP, 1801 California St., Suite 4100, Denver, CO, 80202, US

(21) Appl. No.: 09/858,144

(22) Filed: May 15, 2001

Related U.S. Application Data
(60) Provisional application No. 60/204,627, filed on May 16, 2000.

(51) Int. Cl. H04L 7/00

(52) U.S. Cl. 340/994; 375/356

(57) ABSTRACT

A method and system integrated into and carried out in conjunction with a public transit vehicle arrival information system. The system of the invention comprises at least the receiver portion of a display module which is positioned adjacent a central computer and which provides a received signal indication to the central computer. The received signal indication is, within a fraction of a millisecond, the indicator for signal reception by all receivers in an entire transit system. The central computer uses the received signal indication to calculate the time delay between calculation of arrival times and receipt of the broadcast arrival time data at a plurality of remotely located display modules. The central computer then generates a correction signal which is queued for broadcast to the remote display modules and which instructs the display modules to subtract the calculated time delay from the previously transmitted arrival time.

### FIELD OF THE INVENTION

The present invention relates generally to networks having multiple isolated remote receiving units for receiving broadcast time-dependent information. More specifically, the invention relates to a method and system for use in such networks to correct for variable, unpredictable time delays in the broadcast of time-dependent information to obviate the inaccuracies in such information that would otherwise result from such time delays.

### BACKGROUND OF THE INVENTION

The preferred embodiment of the present invention is configured for use in conjunction with a public transit vehicle arrival information system described in U.S. patent application Ser. No. 08/696,811 filed Aug. 13, 1996, the content of which is hereby incorporated in its entirety herein by reference and should be deemed to be a part of the disclosure hereof. Such a system is designed to permit users of public transit vehicles (i.e., buses) to learn from bus stop displays, how long they must wait before the next bus arrives at a particular bus stop.

The system is applicable to a wide variety of vehicles such as boats, airplanes, helicopters, automobiles, vans, buses, trolleys, and trains, operating along aboveground routes or combination aboveground routes and underground routes including tunnels. The system also is applicable to vehicles which travel along tracks, as well as to those which travel along road surfaces. Typically, the vehicle travels a predetermined route and may be situated at any stop among a plurality of stops or any other location along the route. The system comprises six major classes of devices. These classes are: Vehicle Information Units, the Central Processor, Addressable Display Units, Non-Addressable Display Units, Telephone Information systems and On-Line Computer Information Systems. The vehicle information units are comprised of a global positioning system device or GPS device, located in each vehicle. Also located in each vehicle is an appropriate Passenger Load Sensor System or PLSS for estimating vehicle passenger load. The GPS in each vehicle is in communication with a plurality of global positioning system satellites for determining the location of the vehicle along the vehicle's route. The PLSS is any system that obtains reasonably accurate measurement of vehicle passenger load.

Other sensors may also collect information related to other vehicle systems that may be desirable to monitor such as fuel level, engine temperature, tire pressure, fuel mileage or brake condition, through a variety of additional sensor devices. Collectively the GPS, PLSS and additional sensor devices are referred to herein as the sensors. The sensors are preferably connected to a processor located in each vehicle for accepting data. This processor is in communication with a transceiver that may be individually addressable so that the information received from the sensors can be relayed by wireless radio signal in conjunction with telephone or other available communication systems to a central processor as polled by the central processor or according to a time schedule. The information relayed from the vehicle information units to the central processor includes the transit vehicle identification, its assigned route identification, the coordinates of its location, its current passenger load and any other data collected from additional sensors.

The central processor includes both a transceiver and processor capable of polling the vehicle information units and receiving all information collected by the vehicle information units throughout the Transit System from the vehicle information unit's wireless transmissions in response, to the polling from the central processor or according to a timed schedule. The central processor has access to electronically stored information concerning the vehicles' route. The route information includes the route specifications or map and the location of each of the plurality of stops along the route. The route information includes historical or experience information obtained from calculations of transit time for similar vehicles previously operating between appropriate points on the same transit route and passenger load patterns experienced by other vehicles on the same route. Such historical data is organized according to time of day, date and day of the year (e.g. weekday, Saturday, Sunday, holiday, holiday season, rainy season, dry season). The route information also includes contemporaneous route information received from other vehicles operating on the same route at the same time, as well as operating information such as schedules. The central processor includes means for computing, from the location of the vehicle and the electronically stored information, status information, for example, in the form of transit data tables which include the predicted arrival time of each transit vehicle operating in the system or that will be operating in the system, at each transit stop along each vehicle's route and the predicted passenger load of the vehicle when it arrives at that particular stop. In one aspect, a transit data table comprises a file of electronic records formatted to include in each record the following: Vehicle identification, route number, stop number and the estimated time of arrival at a particular identified stop number together with the predicted passenger load at the identified stop (assuming the transit data table includes one record for each transit stop). Alternatively, each record contains estimated times of arrival at all of the stops along a given vehicle's route together with the predicted passenger load at all of the vehicle's stops (assuming the transit data table includes one record for each vehicle operating on a transit route). In addition, the records may include other useful information, such as but not limited to, special passenger notification information and optimal bus operational information. The transit data table preferably would include records for each stop for each vehicle operating on each route in the transit system. In another aspect, the present information system uses transit and other components, thereby permitting widespread use of the system anywhere in the world.

The central processor routinely updates the transit data tables as new information is received from the vehicle information units. The central processor routinely broadcasts the updated transit data table or tables by wired or wireless transmission, or a combination thereof, throughout the area serviced by the transit system, together with specially addressed information intended only for particular displays known to be operating in the system. The system updates the entire transit data table for a huge transit system in near real time, depending upon broadcast queue delays as will be more fully disclosed hereinafter.

Addressable display devices located at transit stops may, for example, receive transmitted data from the central processor that make the display show not only information related to time remaining before transit vehicles serving that stop arrive, but also intersperse among such information other messages of informational or advertising character.

In one specific aspect, the system comprises using global positioning system devices mounted in individual vehicles which determine the precise coordinate/location of the individual vehicles. That information is transmitted to one or more central computers, preferably via a wireless communication link and more generally via any of the available communications wireless links or hard-wired links, including fiber optics links, radio, satellite, microwave, cellular, telephone and combinations thereof. Then, using the coordinate information and experience (information previously determined and stored in the computer memory regarding vehicle routes, speeds during various times of the day, days of the week, holidays or inclement weather), the central computer(s) generates transit data tables containing current data regarding the routes, locations, velocity/speed, arrival time and future stops and other status and operational information for all vehicles in the system, then controls the broadcast availability of that information in a manner which provides public access to the information via any or all of a number of access devices and systems. The available access means include visual displays, audiovisual displays, telephony, computers or the Internet. In addition, combinations of such devices and systems may be used. For example, a telephone may be used to access the transit data table information. Alternatively, pagers or pager-like devices may be used to display route information.

At each transit stop these are means for accessing the transit data table and other system information, illustratively in the form of one or more display modules. A display module includes a display device, such as a liquid crystal display, a CRT (cathode ray tube) display and/or an LED (light emitting diode) display, for displaying information. Interactive display modules can be used which include, for example, via a link such as a wireless telephone link or a hardwired link. The display modules may be little more than alphanumeric digital pagers of the type regularly available to consumers, or pagers modified with larger screens. These units can be powered from electrical service at the stop, or to save installation costs, and where practical, solar power with battery back-up can be used. These devices may receive the entire transit data table information or a subset thereof. Alternatively, the display modules can be small computers capable of receiving the entire transit data table or a subset thereof and other messages, and capable of being programmed locally, or from the central computer, to format and display those the relevant transit data table and informational messages. In another alternative arrangement, the display modules or units receive the entire transit data table or a subset of the transit data table as well as programming instructions from the central computer so that the content of any particular display can be controlled from the central office.

If the time between the arrival time calculation at the central computer and the display of arrival time at the appropriate bus stop display is trivial, then the displayed arrival time is generally an accurate prediction. Unfortunately, the time between arrival time calculation and display of that time at the bus stops, is often not trivial. More specifically, because transmission to display modules utilizes message paging networks, variable and unpredictable delays on the order of minutes are often encountered. Such delays can have a profound effect on the accuracy of the system. For example, if the central computer calculates that the next bus on line 117 will arrive in 10 minutes, but it takes 2½ minutes to display that period at the display module, by the time the display shows the 10 minute arrival prediction, the actual arrival is only 7½ minutes away. Moreover, because the broadcast delay is not constant and is unpredictable, it cannot be compensated for in advance. Instead, the delay must be measured in real time and the arrival time predictions must be corrected based upon the measured delay. The invention disclosed herein is designed to accomplish these measurement and correction tasks with minimal costs. Of course, it would be possible to provide an accurate time of day header with transmissions to display units at bus stops and the provide an accurate time of day clock at each display unit. The unit could then itself calculate the arrival time regardless of the broadcast delay. However, the cost of such a system (i.e., clock and calculation device in each display) would be considerable.

A search of the prior art has failed to disclose any previously patented system for accomplishing the aforementioned tasks. By way of illustration, the following patents appear to be the most pertinent:

U.S. Pat. No. 5,812,528 is directed to measuring round trip time in ATM network virtual connections. Round trip travel time of cells in an asynchronous transfer mode (ATM) communications network is measured by injecting a time stamp into test cells in a first test instrument, transmitting these test cells to a remote node in the network, looping the test cells back from the remote node to an originating node and detecting their arrival. An ATM network is indicated in FIG. 1 and it may transmit digitized voice, video or data. The signal is divided into a large number of cells of identical format. A test instrument may be connected to a conventional pre-existing node 42 of an ATM network using the methods shown in FIG. 3A-FIG. 3C. The test processor 60 implemented as a real time embedded processing system performs the various processing steps required to carry out the tests. The cell time of departure time stamp written into the payload of a test cell indicates when the cell is introduced into the ATM network. The cell time of arrival time stamp similarly indicates when the cell is extracted from the ATM network. The round trip time is computed by a subtraction of these two quantities.

U.S. Pat. No. 5,563,875 is directed to a wrap-around route testing and packet communication network. FIG. 1 shows a particular implementation of a packet transmission system 10 comprising eight network nodes 11, number 1-8. Each of the network nodes is linked to others of the network by one or more communication links A-L.A. wrap-around test is implemented in the packet systems using pre-calculated routes over the network by generating a plurality of wrap-around test messages, one for each node in the pre-calculated route. Each such wrap-around test message is directed to a different node in the pre-calculated path. The intermediate and destination nodes treat these wrap-around test messages exactly the same 1 as data messages, and hence no modifications to the intermediate and destination nodes are required. As each wrap-around test message is launched in the network, the time of launching is noted. When each wrap-around message is returned to the original node, the reception time is noted. The transit time of that message then is one-half of the difference between the launching time of the reception time of the wrap-around message. The transit time of each leg of the route can then be calculated as the difference between the transit times to the two nodes immediately adjacent to the leg. Finally, the overall route delay is simply the sum of the transit times of all the legs in that route.

U.S. Pat. No. 5,586,119 is directed to a method and apparatus for packet alignment in the communications system. A cellular radio telephone system having radio communication base stations 130-134 of cells 100-104 each coupled to base site controller or a central communications controller 120 is shown in FIG. 1. The system contains a communications controller 310 having a vocoder and an input/output processor 313. The input/output processor has a timing alignment control 315 and a packet counter 314 for inserting timing alignment tags in voice data packets and adjusting packet number and timing based on alignment requests from a master radio communication unit. The communications controller is coupled to radio communications units 330, 340 and 350, each having a packet buffer 331 and an alignment processor 332 which includes a packet number detector 333 for detecting a timing transmission tag and sending request for packet number adjustment to the communications controller and a timing alignment detector 334 for comparing a received time and for sending a timing alignment request to the communication controller. The mobile radio telephone moves through the cellular system requiring hand-off of communication between the subscriber and its serving base station. This hand-off process can only be successful if both base stations transmit the same information at the same time. Processor 313 is configured to insert packet frame number information i.e., timing transmission tags and receive timing adjustment requests.

U.S. Pat. No. 5,784,421 is directed to a computer program for use with a network node for performing anonymous time synchronization in a network. This method is based on reference time stamps according to one of the time scales to a repository of the other of the time scales and on local time stamp marks according to the other time scale produced by the repository of the other time scale as it receives the messages. The messages are transmitted according to a predetermined protocol. Based on the protocol temporal relationships are determined between events corresponding with the reference time stamps in the messages, the events of creation of the messages and events corresponding with the local time stamp marks, i.e., the events of receipt of the messages. Network node 2 is coupled for communication within an architecture including networks 4, 6, 8, 10 and 12, as indicated in FIG. 1. Each of these networks may be token ring network, an Ethernet network, or any other suitable communication network configuration. Time synchronization messages are sent anonymously, thus, a node serving as a master of a network or communication link need not concern itself with the exact configuration of the network or link, the number of nodes, their logical identities, etc. The master node synchronizes time for the slave nodes by sending a burst or series of synchronization messages. Each synchronization message sent by the master node includes a reference time stamp based on the reference time provided to the master node by the external time source. Each slave on receipt of a burst of time synchronization messages, synchronizes its internal time based on the time stamps provided in the synchronization messages.

U.S. Pat. No. 5,521,907 is directed to a method and apparatus for non-intrusive measurement of round trip delay in communication networks. One object of this system is to provide a method and apparatus for measuring the round trip delay or travel time in communication network without requiring measurement of specific data, but instead processing the actual data stream that happens to be transmitted in a network regardless of the protocol. FIG. 1 shows an implementation which can be used to describe the process. Site A and B are connected in the packetized data communication network by communication lines 10 and 11. Two probes 12 and 13 are each connected to both communication lines 10 and 11 at respective monitoring pints and to capture and process data packets being set between sides A and B. Each probe captures identifiable data patterns arriving at and departing its respective monitor point and generates a time stamp through use of microprocessor 36 indicating the time of arrival or departure. The probe also generates a pattern identifier driven from the data in the identifiable data pattern to uniquely identify that identifiable data pattern and stores the time stamp and corresponding pattern identifier in an internal buffer. The probes 12 and 13 collect data in their respective buffers. The collected data is sent to console 16 for processing. Console 16, after determining matches in the two buffers, uses the arrival and departure time stamps of the packets to calculate the round trip delay or travel time.

U.S. Pat. No. 5,261,118 is directed to a simulcast synchronization system and method. The system 10 includes a control station for controlling the distribution of system timing signals used for transmission clock synchronization and message transmission timing, a communications satellite 14, and a plurality of transmission stations such as stations 16 and 18 shown in FIG. 1. A master clock 22 generates the system timing signals. Transmitter 24 transmits the system timing signals to the satellite 14 which then retransmits the timing signals throughout the system 10. The timing signals when received by the satellite receiver 26 are sent to comparator 28 which compares the time of arrival of the system timing signals with the time of transmission of the signals in order to establish a time adjustment factor which is used to synchronize the transmission clocks used throughout the system. The time correction factor determined at the control station 12 is used by the transmission stations 16 and 18, together with the system timing signal arrival information measured at each station 16 and 18 to calculate the time corrections necessary to synchronize the local clocks at each transmission station. The timing information calculated at the control station is periodically transmitted to the transmission stations to update the local clocks.

Thus, there is still a need for a time correction method and apparatus which does not require a local time of day clock in each display unit along with local time calculation at each display unit.

### SUMMARY OF THE INVENTION

In a widely distributed one-way radio network, such as a paging network, there is a need for reliable network-wide timing to enable, among other things, the use of GPS for synchronized vehicle tracking (the envisioned application of a preferred embodimentof the invention). The problem arises in determining the time elapsed from the moment a time-stamp is set by a control unit and then transmitted to the moment the transmission is received around the network (disregarding any small variations in this latency due to variations in distance from the transmitter—an easily disregarded quantity given the speed of light).

The present invention is in its preferred embodiment, integrated into and carried out in conjunction with the public transit vehicle arrival information system of Applicant's co-pending application. The system of the invention comprises at least the receiver portion of a display module which is positioned adjacent the central computer and which provides a received signal indication to the central computer. The received signal indication is, within a fraction of a millisecond, the indicator for signal reception by all receivers in the entire transit system. The central computer uses the received signal indication to calculate the time delay between calculation of arrival times and receipt of the broadcast arrival time data at the display modules. The central computer then generates a correction signal which is queued for broadcast to the display modules and which instructs the display modules to subtract the calculated time delay from the previously transmitted arrival time. Thus, the present invention provides the needed real time measurement of broadcast time delay and the correction signal to compensate for the delay. Moreover, the present invention obviates the use of time of day headers, local time of day clocks and local calculators that are required in more conventional time correction broadcast systems found in the prior art.

The heart of the invention comprises the control unit tagging each transmission with a recognizable stamp and receiving back at the control unit. A latency measurement is then easily made and transmitted as a follow-on to the network. Disregarding variations in distance from the transmitter, a reliable delay measurement is thereby forwarded to the network.

The present invention thus provides correction for variable and unpredictable time delays in networks having multiple isolated remote receiving units for receiving broadcast time-dependent information.

The invention also provides a method for measuring in real time the delay incurred between queuing data for broadcast and actually broadcasting the queued data.

The invention also provides a method and system for decreasing inaccuracies in the display of predicted arrival times at a plurality of remote stations of a public transit system by correcting for broadcasting delays caused by queuing data traffic and the like.

The invention also provides a low cost network time correction process which permits base station calculation of correction data and without requiring each of a plurality of remote receivers to calculate its own correction data.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a conceptual drawing of a broadcast system into which the present invention is designed to be integrated;

FIG. 2 is a conceptual drawing of a broadcast system into which the present invention is integrated;

FIG. 3 is a block diagram illustrating the steps of the method of the invention.

### DETAILED DESCRIPTION OF A PREFERRED EMBODIMENT

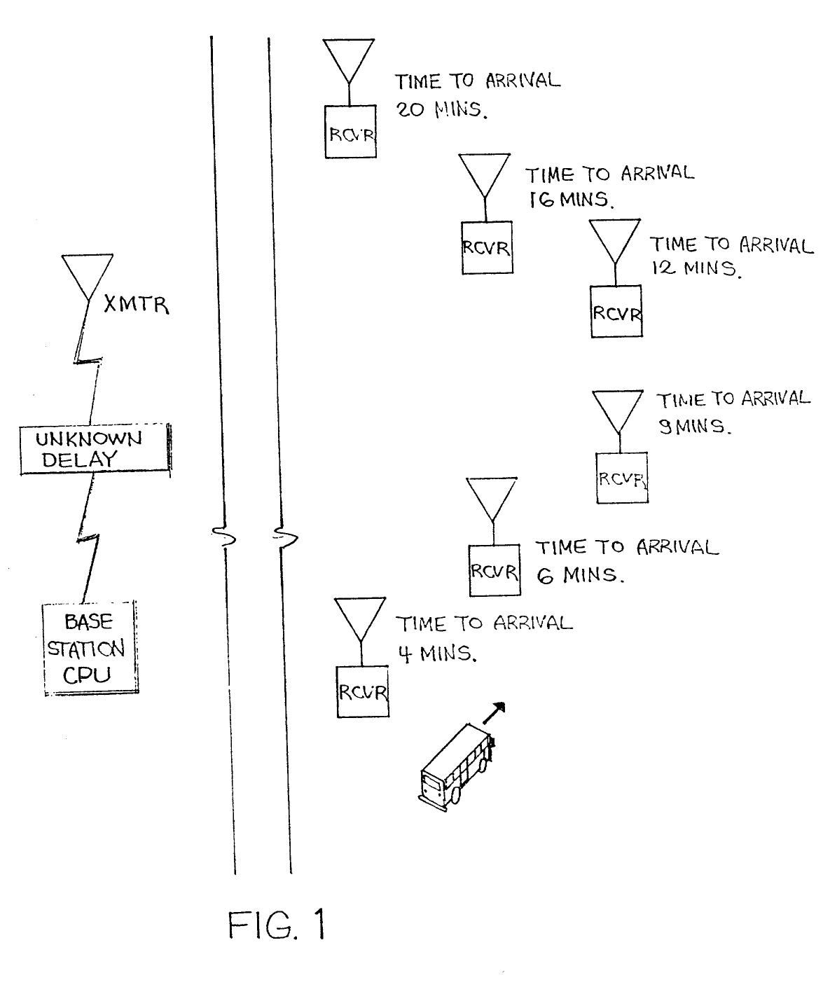

Referring to FIG. 1, it will be seen that a transit system for use with the present invention, comprises a plurality of remote, isolated receivers at various sequential locations along the route of a public transport vehicle such as a bus. Typically, at some central location, the system also comprises a base station. As previously described, each bus has a GPS receiver and other sensors the data from which is transmitted to the base station. The base station computer then calculates or looks up a table to derive predicted arrival times at the various locations (i.e., bus stops) along the route of each bus. This arrival time data is then queued for broadcast such as by means of a paging system. However, because the paging system may be burdened with a heavy traffic load, the actual time of broadcast to the remote receivers may be delayed by periods of up to one or two minutes. This delay, which is represented in FIG. 1 by the block labeled “UNKNOWN DELAY”, would produce inaccuracies in the time of arrival data sent to the remote receivers. Specifically, if it takes two minutes to broadcast the data from the base station to the remote receivers, then each receiver will begin a countdown that is already two minutes behind actual arrival times. Consequently, waiting bus passengers will read X minutes on their respective display modules when, in fact, the bus will arrive in about X-2 minutes.

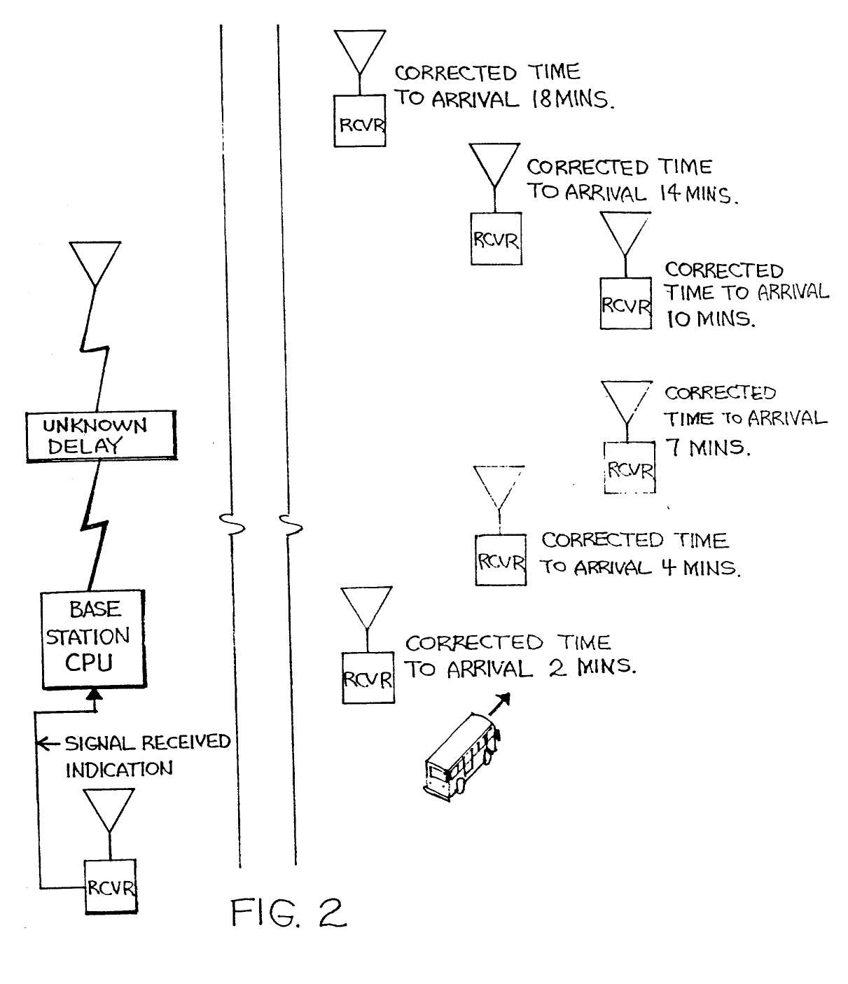

The present invention provides a low cost solution to this potentially profound inaccuracy. More specifically, referring to FIG. 2, it will be seen that in the present invention an additional receiver is positioned generally adjacent the base station central computer and provides a signal received indication or SRI. This SRI will, because of the virtually instantaneous transmission of electromagnetic energy over relatively short distances (i.e., 20 miles or less), be substantially coincident with the receipt of time of arrival data by all of the remote receivers throughout the route of the selected bus. The SRI thus indicates the end of the period of unknown delay due to queuing for broadcast. The base station computer can thus readily calculate the total period of unknown delay by simply tracking the elapsed time between its output of data for broadcast and its receipt of the SRI.

The calculated delay is then itself broadcast as a correction signal to all remote receivers. Each remote display module is instructed to subtract from its time of arrival display data, a period corresponding to the measured broadcast delay of the previously transmitted data. Each remote display module will already be counting down the previously received time of arrival data so that any further broadcast delay in regard to the correction signal will only postpone the correction of the time of arrival displayed. However, ultimately the correction signal will be received at the remote display modules and will result in accurate displays for remaining time to arrival of the next bus at the corresponding bus stop.

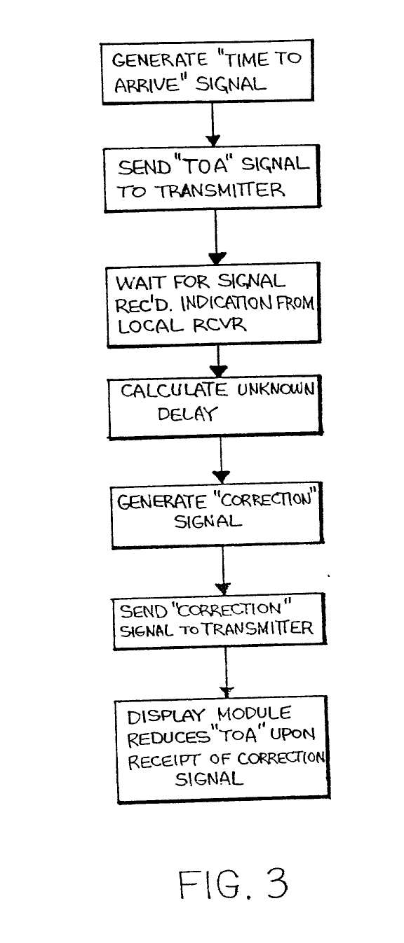

FIG. 3 depicts the steps in the correction process of the present invention. Specifically, as seen in FIG. 3, the initial step is that of calculating “time to arrival” or “TOA” data for the remote displays of one or more selected routes. This step is accomplished in the manner described in detail in the Applicant's co-pending application Ser. No. 08/696,811, the content of which has been incorporated herein by reference. The next step is to send the “TOA” signals to the transmitter. This step will, of course, depend upon the mode of broadcast and the computer/broadcast interface. In a preferred embodiment, this step is accomplished by a telephone data interface with a paging broadcast service which queues the data for broadcast in due course depending upon the amount of other data awaiting broadcast over pager frequencies. The next step in the process of the invention is that of waiting for the local receiver to generate the SRI as previously described. The base station computer then calculates the unknown delay by tracking the elapsed time between data queuing and SRI. The next step is accomplished at the base station computer by generating the correction signal. The correction signal is generally an instruction to the display modules to subtract the amount of calculated delay time from the currently displayed time to arrival. This instruction is then forwarded to the transmitter for broadcast to the remote display modules as the next step in the process. Upon receipt of the correction signal, the respective display modules adjust the displayed time to arrival by the period of the correction.

Having thus disclosed a preferred embodiment of the invention, it should be understood that numerous modifications and additions are contemplated.

What is claimed is:

1. In a network having a plurality of remotely located receiving units and a base station computer generating time-dependent data and having a data interface with a transmitter for broadcasting the time-dependent data to the receiving units, the data interface causing an unpredictable, variable delay between the generation of data by the computer and broadcasting of the data by the transmitter; an apparatus comprising:
a local receiving unit positioned in proximity to said base station computer and generating a signal received indication upon receiving said broadcast data, said signal received indication being input to said base computer for calculation of the elapsed time between said computer generation of data and said signal received indication, said elapsed time being substantially equal to said delay; and
means in said computer for generating a correction signal for broadcast to said receiving units, said correction signal instructing said receiving units to compensate for said elapsed time.

2. The apparatus recited in claim 1 wherein said network is a public transit vehicle arrival information system, wherein said time-dependent data is time-to-arrive prediction data for vehicles in said system and wherein said receiving units are display modules at vehicle stations along vehicle routes and said local receiving unit comprises at least a receiving portion of said display modules.

3. The apparatus recited in claim 2 wherein said correction signal comprises an instruction to said receiving units to subtract said elapsed time from said time to arrive prediction data.

4. The apparatus recited in claim 1 wherein said local receiving unit is hard wired to said base station computer.

5. In a public transit vehicle arrival information system having a plurality of remotely located receiving and display modules at transit vehicle stations throughout a selected geographical area along transit vehicle routes, said system also having a base station computer for receiving transit vehicle location data and generating arrival prediction data for broadcast to said modules, said computer being connected to a data interface for transmission of said arrival prediction data to a broadcasting system, said data interface and broadcasting system causing an unpredictable delay; an apparatus comprising:
a local receiving unit positioned in proximity to said base station computer and generating a signal received indication upon receiving said broadcast data, said signal received indication being input to said base computer for calculation of the elapsed time between said computer generation of data and said signal received indication, said elapsed time being substantially equal to said delay; and
means in said computer for generating a correction signal for broadcast to said receiving units, said correction signal instructing said receiving units to compensate for said elapsed time.

6. The apparatus recited in claim 4 wherein said data interface is a telephone modem and wherein said broadcasting system is a paging service and wherein said unpredictable delay is dependent upon the time to transfer said data to said paging service and upon the time to broadcast said data by said paging service.

7. In a network having a plurality of remotely located receiving units and a base station computer generating time-dependent data and having a data interface with a transmitter for broadcasting the time-dependent data to the receiving units, the data interface causing an unpredictable, variable delay between the generation of data by the computer and broadcasting of the data by the transmitter; the method comprising the steps of:
providing a local receiving unit positioned in proximity to said base station computer;
said local receiving unit generating a signal received indication upon receiving said broadcast data;
inputting said signal received indication to said computer;
calculating the elapsed time between said computer generation of data and said signal received indication;
generating a correction signal for broadcast to said receiving units, said correction signal instructing said receiving units to compensate for said elapsed time.

8. In a public transit vehicle arrival information system having a plurality of remotely located receiving and display modules at transit vehicle stations throughout a selected geographical area along transit vehicle routes, said system also having a base station computer for receiving transit vehicle location data and generating arrival prediction data for broadcast to said modules, said computer being connected to a data interface for transmission of said arrival prediction data to a broadcasting system, said data interface and broadcasting system causing an unpredictable delay; the method comprising the steps of:
providing a local receiving unit in direct communication with said base station computer;
said local receiving unit generating a signal received indication upon receiving said broadcast data;
inputting said signal received indication to said computer;
calculating the elapsed time between said computer generation of data and said signal received indication;
generating a correction signal for broadcast to said receiving units, said correction signal instructing said receiving units to compensate for said elapsed time.

9. An apparatus for synchronizing time on a plurality of nodes in a one-way broadcast network, comprising:
a base station having a controller;
a plurality of receivers located remotely from said base station controller;
a special receiver located within direct communication distance of the base station controller and able to communicate to the base station;
means for encoding the current time in a time stamp message, and means for queueing that message for transmission to said plurality of receivers and to said special receiver;
means for recognizing the reception of the time stamp message at the special receiver, and calculating the latency between said queueing and said reception;
means for encoding the measured latency in a correction message;
means for queueing that message for transmission; and
means for the remote receivers to determine the correct time based on the time stamp message, as adjusted by the correction message.

10. The apparatus of claim 9, where the special receiver is located remotely from the base station, shares a time reference with said base station and can communicate sufficient time data to the base station to enable said calculation.

11. The apparatus of claim 9, where an additional message is sent encoding the projected arrival time of a vehicle, enabling a determination of the relative time to arrival at each said remote receiver.

12. The apparatus of claim 9, where an additional message is sent encoding the measured position of a vehicle, enabling the display of a projection of said vehicle's current location at each said remote receiver.

13. The apparatus of claim 9, where the synchronization of said remote receivers to said base station provides the correct local time to a user of a one-way pager utilizing at least one of said remote receivers.
